(19) United States
(12) Patent Application Publication
(10) Pub. No.: US 2019/0137903 A1
(43) Pub. Date: May 9, 2019

(54) CLEANING ROLLER, CHARGING DEVICE, IMAGE FORMING APPARATUS INCLUDING CLEANING ROLLER OR CHARGING DEVICE, AND METHOD OF MANUFACTURING CLEANING ROLLER

(71) Applicant: SHARP KABUSHIKI KAISHA, Sakai City (JP)

(72) Inventor: KATSUMI ADACHI, Sakai City (JP)

(21) Appl. No.: 16/182,536

(22) Filed: Nov. 6, 2018

(30) Foreign Application Priority Data
Nov. 7, 2017 (JP) 2017-215041

(51) Int. Cl. G03G 15/02; B29C 47/00; B29C 45/14; B29C 45/40

(52) U.S. Cl. CPC G03G 15/0291; B29C 47/003; B29K 2105/04; B29C 45/40; B29C 45/14336

(57) ABSTRACT

In a cleaning roller, a plurality of uneven portions are formed on a surface. A rotation shaft of the cleaning roller is inserted into a cylindrical hole of a cylindrical cleaning member in which the plurality of uneven portions are formed, and the clean member and a rotation shaft are fixed in a state where the cleaning member is twisted in a circumferential direction. The cleaning member, in which the plurality of uneven portions extending so as to twist in the circumferential direction are formed, is molded by rotating an extrusion molding die while extruding an extrusion molding material toward an extrusion molding hole of the extrusion molding die. An injection molding material with which the injection molding die is filled is solidified to mold the cleaning member and the cleaning member is stripped from the injection molding die by rotating the extrusion molding die around an axis.

### BACKGROUND

### 1. Field

The present disclosure relates to a cleaning roller which is in contact with a cleaning object to clean the cleaning object, a charging device, a copying machine including the cleaning roller or the charging device, an image forming apparatus such as a multifunction device, a printer, and a facsimile machine, and a method of manufacturing a cleaning roller.

### 2. Description of the Related Art

A cleaning roller generally includes a cleaning member made of cylindrical foam. In such a cleaning roller, permanent deformation (permanent compression distortion) may occur by being in contact with a cleaning object (for example, a charging roller) for a long period of time. Then, inconvenience due to permanent deformation such as rotation fluctuation (for example, nonuniformity of a circumferential speed and vibration of the cleaning roller, and fluctuation of a friction force with the cleaning object) of the cleaning roller may occur.

Regarding this point, as the cleaning member of the cleaning roller, for example, one in which strip-shaped cleaning member is wound around a rotation shaft may be used (see Japanese Patent No. 5472440, Japanese Patent No. 5170115, and Japanese Patent No. 5402275). Specifically, Japanese Patent No. 5472440 discloses a cleaning roller in which foam is spirally wound around a core material. Japanese Patent No. 5170115 discloses a cleaning roller in which foam is spirally fixed to a core material so that end portions of a cross section of the foam are higher than a center portion. In addition, Japanese Patent No. 5402275 discloses a cleaning roller having a structure in which a band portion is spirally wound around a shaft portion so that end portions are not in contact with a charging roller in order to avoid peeling and chipping of the band portion.

In the cleaning rollers described in Japanese Patent No. 5472440, Japanese Patent No. 5170115, and Japanese Patent No. 5402275, a contact length of a contact portion with the cleaning object in an axial direction is small and a fluctuation of the friction force with the cleaning object due to the permanent deformation may be suppressed. However, due to variation in shape of the foam, fluctuation in tension at the time of winding, or the like, a shape may change when the foam is wound around the core material. Then, a contact state of the cleaning roller with the cleaning object tends to vary and cleaning performance of the cleaning roller is biased. That is, a ratio of a cleanable portion on an outer periphery surface of the cleaning roller to the cleaning object (for example, a charging roller) is small. Therefore, as described above, if there is a deformation failure in the foam, for example, there is a concern that contamination of the charging roller facing the cleanable portion is promoted. Furthermore, a driven rotation with the charging roller is liable to become unstable, which causes rotation fluctuation of the cleaning roller, so that there is a concern that image formation is adversely affected. Therefore, in the cleaning rollers described in Japanese Patent No. 5472440, Japanese Patent No. 5170115, and Japanese Patent No. 5402275, it is impossible to eliminate inconvenience due to the rotation fluctuation of the cleaning roller. In addition, in the cleaning roller described in Japanese Patent No. 5402275, in order to avoid peeling or chipping of the band portion, an unnecessary region for the cleaning roller has to be provided in a longitudinal direction, which leads to an increase in size of the apparatus.

### SUMMARY

It is desirable to provide a cleaning roller, a charging device, an image forming apparatus including the cleaning roller or the charging device, and a method of manufacturing a cleaning roller in which inconvenience due to rotation fluctuation of the cleaning roller may be effectively eliminated and downsizing of the apparatus may be realized.

The disclosure provides a cleaning roller, a charging device, an image forming apparatus, and methods of manufacturing a cleaning roller of a first aspect to a third aspect as follows.

According to an aspect of the disclosure, there is provided a cleaning roller which is in contact with a cleaning object to clean the cleaning object, in which a plurality of uneven portions extending so as to twist in a circumferential direction of the cleaning roller are formed on an outer periphery surface of the cleaning roller.

According to another aspect of the disclosure, there is provided a charging device including: the cleaning roller according to the disclosure; and a charging roller, in which the cleaning roller is in contact with the charging roller to clean the charging roller.

According to still another aspect of the disclosure, there is provided an image forming apparatus including the cleaning roller according to the disclosure or the charging device according to the disclosure.

According to still another aspect of the disclosure, there is provided a method of manufacturing a cleaning roller which is in contact with a cleaning object to clean the cleaning object, the method including: inserting a rotation shaft of the cleaning roller into a cylindrical hole of a cylindrical cleaning member in which a plurality of uneven portions extending in a longitudinal direction are formed on an outer periphery surface along an axial direction; and fixing the cleaning member and the rotation shaft in a state where the cleaning member, into which the rotation shaft of the cleaning roller is inserted, is twisted in a circumferential direction.

According to still another aspect of the disclosure, there is provided a method of manufacturing a cleaning roller which is in contact with a cleaning object to clean the cleaning object, the method including: extruding an extrusion molding material toward an extrusion molding hole of an extrusion molding die having the extrusion molding hole having a circular cross section in which a plurality of uneven portion for injection molding are formed throughout an entire circumferential direction; and molding a cleaning member, in which a plurality of uneven portions extending so as to twist in a circumferential direction are formed on an outer periphery surface by rotating the extrusion molding die in a predetermined rotation direction around an axis along an extrusion direction of the extrusion molding material when the extrusion molding material passes through the extrusion molding hole of the extrusion molding die.

According to still another aspect of the disclosure, there is provided a method of manufacturing a cleaning roller which is in contact with a cleaning object to clean the cleaning object, the method including: filling an injection molding die in which a plurality of uneven portions for injection molding extending so as to twist in a circumferential direction are formed on an inner periphery surface, with an injection molding material; molding a cleaning member in which a plurality of uneven portions extending so as to twist in a circumferential direction are formed by solidifying the injection molding material with which the injection molding die is filled; and stripping the cleaning member from the injection molding die by rotating the injection molding die around an axis.

### BRIEF DESCRIPTION OF THE DRAWINGS

FIG. 1 is a sectional view schematically illustrating a configuration of an image forming apparatus including a cleaning roller according to an embodiment of the disclosure;

FIG. 2 is a schematic perspective view schematically illustrating the cleaning roller and a charging roller according to a first embodiment;

FIG. 3 is a schematic plan view schematically illustrating the cleaning roller according to the first embodiment;

FIG. 4 is a schematic sectional view schematically illustrating the cleaning roller according to the first embodiment;

FIG. 5 is a schematic perspective view schematically illustrating a cleaning roller and a charging roller according to a second embodiment;

FIG. 6 is a schematic sectional view schematically illustrating the cleaning roller according to the second embodiment;

FIG. 7 is a schematic sectional view schematically illustrating a cleaning roller according to a third embodiment;

FIGS. 8A and 8B are developed views illustrating an outer periphery surface of the cleaning roller developed in a circumferential direction, in which FIG. 8A is a view illustrating a case where a twist angle is small and FIG. 8B is a view illustrating a case where the twist angle is large;

FIG. 9 is a table illustrating evaluation results of Example 1;

FIG. 10 is a table illustrating evaluation results of Example 2;

FIG. 11 is a table illustrating evaluation results of Example 3;

FIG. 12 is a schematic plan view schematically illustrating a state before a cleaning member is fixed to a rotation shaft in a method of manufacturing a cleaning roller of a first aspect;

FIG. 13 is a schematic perspective view schematically illustrating a state where a cleaning member is extrusion-molded in a method of manufacturing a cleaning roller of a second aspect; and

FIG. 14 is a schematic sectional view schematically illustrating an injection molding die for extrusion-molding a cleaning member in a method of manufacturing a cleaning roller of a third aspect.

### DESCRIPTION OF THE EMBODIMENTS

Hereinafter, embodiments of the disclosure will be described with reference to the drawings. In the following description, the same reference symbols are given to the same components. Their names and functions are also the same. Therefore, detailed description thereof will not be repeated.

### Configuration of Image Forming Apparatus

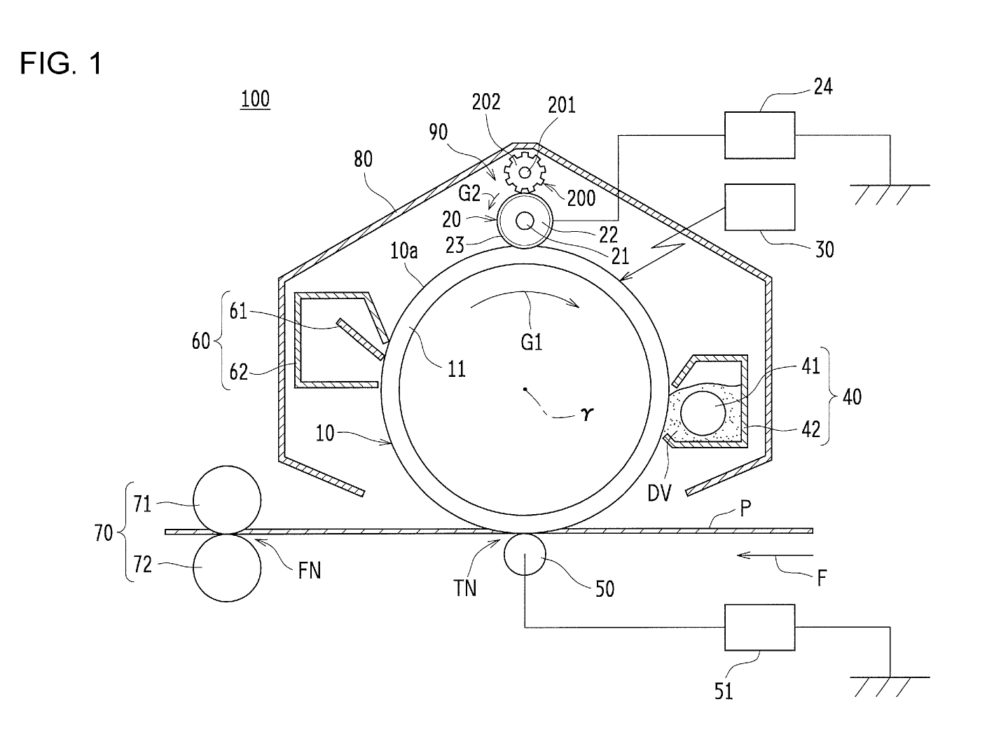

FIG. 1 is a sectional view schematically illustrating a configuration of an image forming apparatus 100 including a cleaning roller 200 according to an embodiment of the disclosure.

As illustrated in FIG. 1, the image forming apparatus 100 includes a photosensitive drum 10 as an image carrier, a charging device 90, an exposure device 30, developing device 40, a transfer charging device 50, a cleaning device 60, and a fixing device 70. The charging device 90 charges a surface 10a of the photosensitive drum 10. The exposure device 30 exposes the photosensitive drum 10 which is charged by the charging device 90 to form an electrostatic latent image. The developing device 40 develops the electrostatic latent image formed by the exposure device 30 to form a toner image. The transfer charging device 50 transfers the toner image formed by the developing device 40 on a recording medium P such as recording paper. The cleaning device 60 removes and collects toner remaining on the photosensitive drum 10. The fixing device 70 fixes the toner image transferred by the transfer charging device 50 an the recording medium P to form an image. In the example, the image forming apparatus 100 is assumed to be a monochrome printer a laser printer). Moreover, the image forming apparatus 100 may be, for example, an intermediate transfer type color image forming apparatus by which a color image can be formed. In addition, in the example, although the image forming apparatus 100 is a printer, it may be, for example, a copying machine, a multifunction device, or a facsimile machine.

In the photosensitive drum 10, a base 11 is rotatably supported by a body frame (not illustrated) of the image forming apparatus 100 and is rotationally driven by a driving unit (not illustrated) in a predetermined rotation direction G1 (clockwise direction in the drawing) around a rotation axis γ.

The charging device 90 includes a charging roller (an example of a cleaning object) serving as a charging member and the cleaning roller 200. The charging roller 20 uniformly charges the surface 10a of the photosensitive drum 10 to a predetermined potential by a high voltage applying device 24. The charging roller 20 rotates at the same or substantially the same circumferential speed as that of the photosensitive drum 10. The charging roller 20 includes a rotation shaft 21, a cylindrical elastic member 22 formed on the rotation shaft 21, and a resistance layer 23 formed on the elastic member 22. An outer diameter of the charging roller is not limited but may be approximately 8 mm to 14 mm. As the rotation shaft 21, for example, a metal material may be used. The elastic member 22 has adequate electroconductivity to ensure power supply to the photosensitive drum 10. The resistance layer 23 adjusts electric resistance of the entire charging roller 20.

The cleaning roller 200 is for removing foreign matters such as residual toners, external additives for toner, paper dust, or the like adhering to the surface of the charging roller 20. The cleaning roller 200 includes a rotation shaft 201 and a cylindrical cleaning member 202 fixed to the rotation shaft 201. In this example, the rotation shaft 201 is a shaft having a diameter of 4 mm. The rotation shaft 201 is not particularly limited and may be formed of a general material. Examples of a material which may be used for the rotation shaft 201 include, for example, stainless steel, SUM, iron, nickel, aluminum, or the like. The cleaning member 202 is made of an elastic member, in this example, elastic foam (sponge layer). A distance between the axis of the cleaning roller 200 and the axis of the charging roller 20 in a state in which the cleaning roller 200 is in pressure contact with the charging roller 20 may be constant, or the cleaning roller 200 may be freely movable in a direction of contact and separation with respect to the charging roller 20, or may be pressed against the charging roller 20 by a pressing device such as a spring (not illustrated). Therefore, the cleaning member 202 is compressed and deformed (a so-called biting) by a predetermined amount (for example, substantially 0.5 mm to 1 mm) to the charging roller 20. The elastic foam is not particularly limited and may be a foam material which is generally used. Examples of the elastic foam include, for example, an organic rubber such as polyurethane, isoprene rubber (IR), nitrile rubber (NBR), or ethylene propylene diene monomer (EPDM) rubber, or foam using at least one of polyethylenes, polyester resin, polypropylenes, polyamides, polyurethanes, and epoxy resin. A surface structure of the cleaning roller 200 and a method of manufacturing the cleaning roller 200 will be described in detail later.

The exposure device 30 repeatedly scans the surface 10a of the photosensitive drum 10 that is rotationally driven with light modulated based on image information in the direction of the rotation axis γ of the photosensitive drum 10, which is a main scanning direction. The developing device 40 includes a developing roller 41 and a developing tank 42. The developing roller 41 supplies a developing agent DV to the surface 10a of the photosensitive drum 10. The developing tank 42 accommodates the developing agent DV. The transfer charging device 50 apples a predetermined high voltage to a transfer nip portion TN formed between the photosensitive drum 10 and the transfer charging device 50 by a high voltage applying device 51. The cleaning device 60 includes a cleaning blade 61 and a recovery casing 62. The cleaning blade 61 removes the toner remaining on the surface 10a of the photosensitive drum 10. The recovery casing 62 accommodates the toner removed by the cleaning blade 61. The fixing device 70 includes a heating roller 71 and a pressure roller 72. The pressure roller 72 is pressed against the heating roller 71 to form a fixing nip portion FN. In addition, the image forming apparatus 100 further includes a housing 80 that accommodates each configuration element configuring the image forming apparatus 100. In FIG. 1, reference symbol F indicates a carrying direction of the recording medium P.

### Cleaning Roller

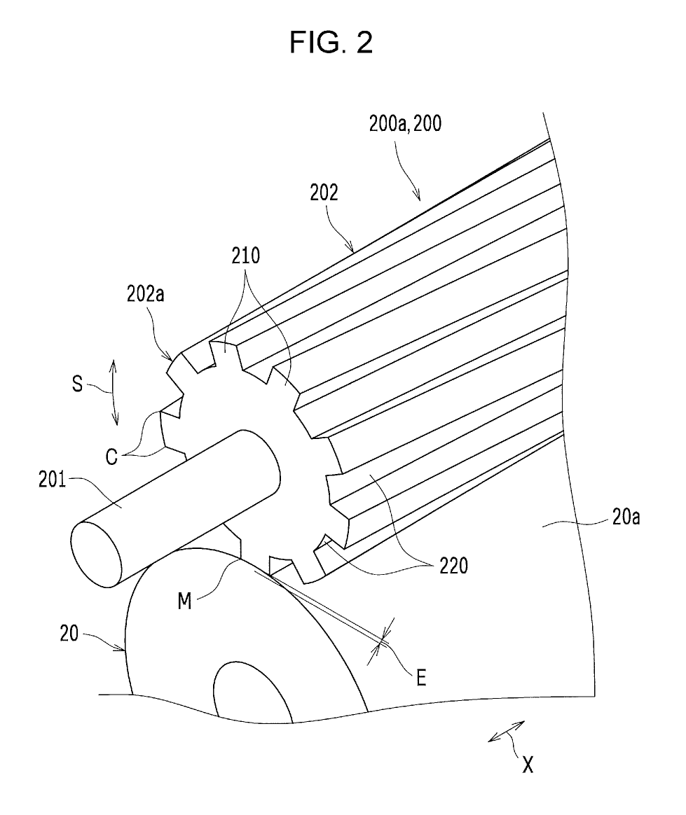

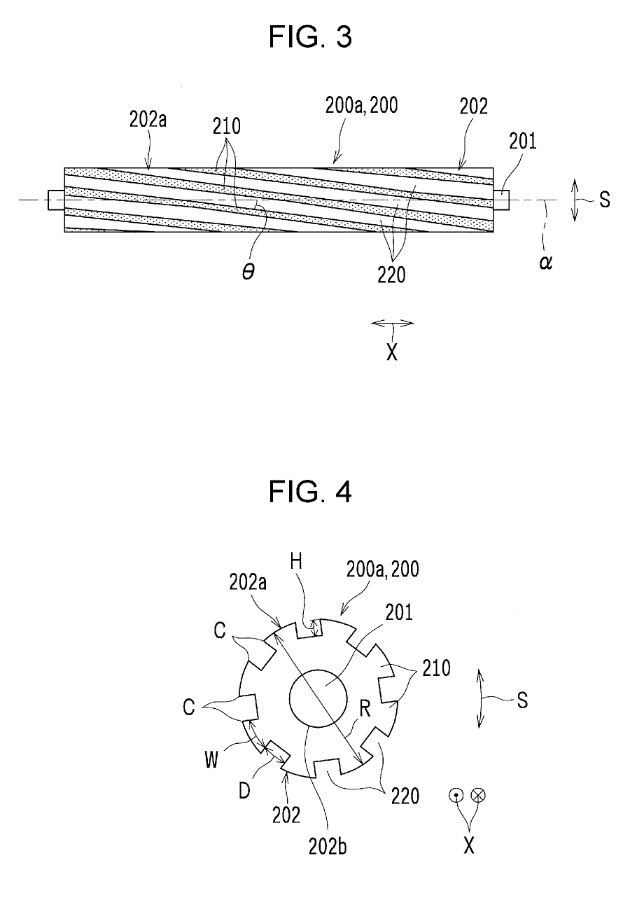

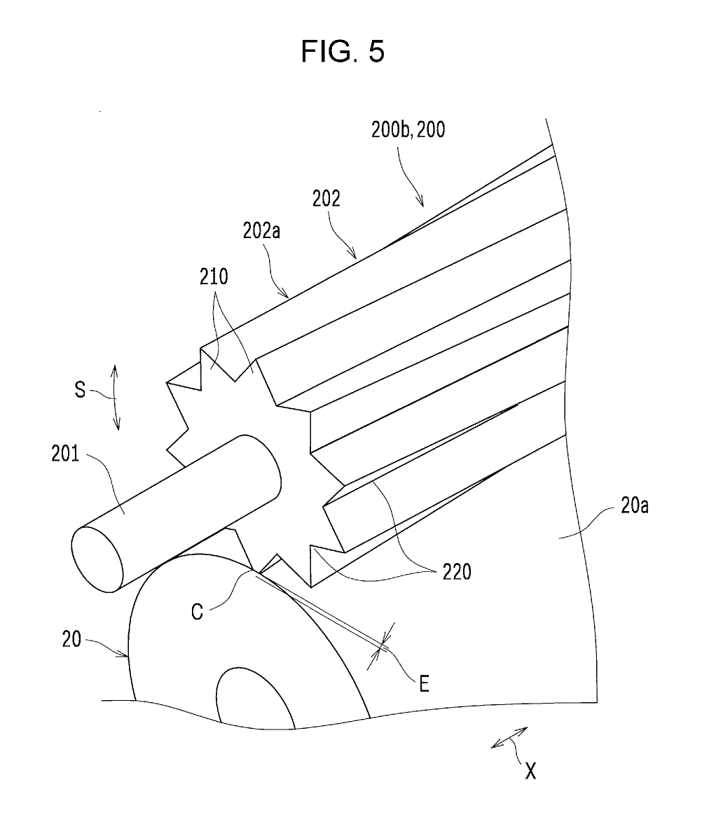

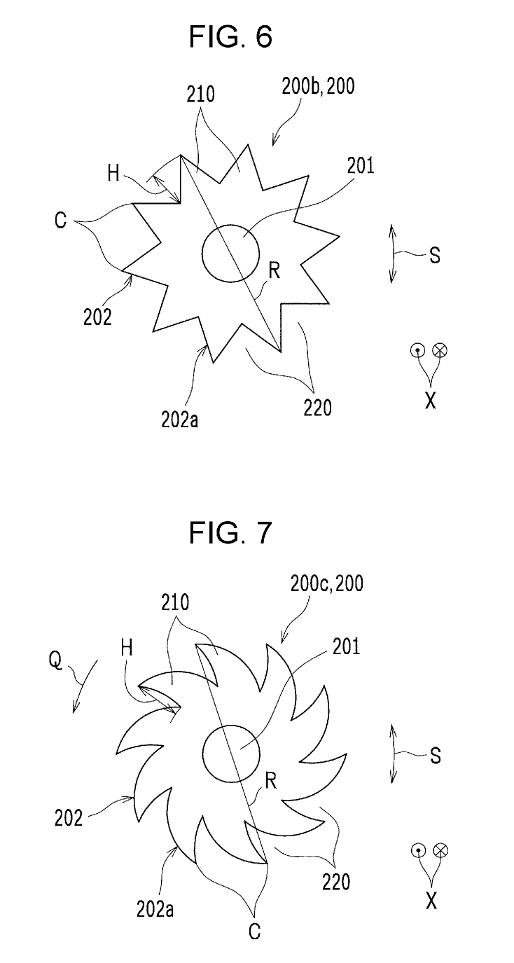

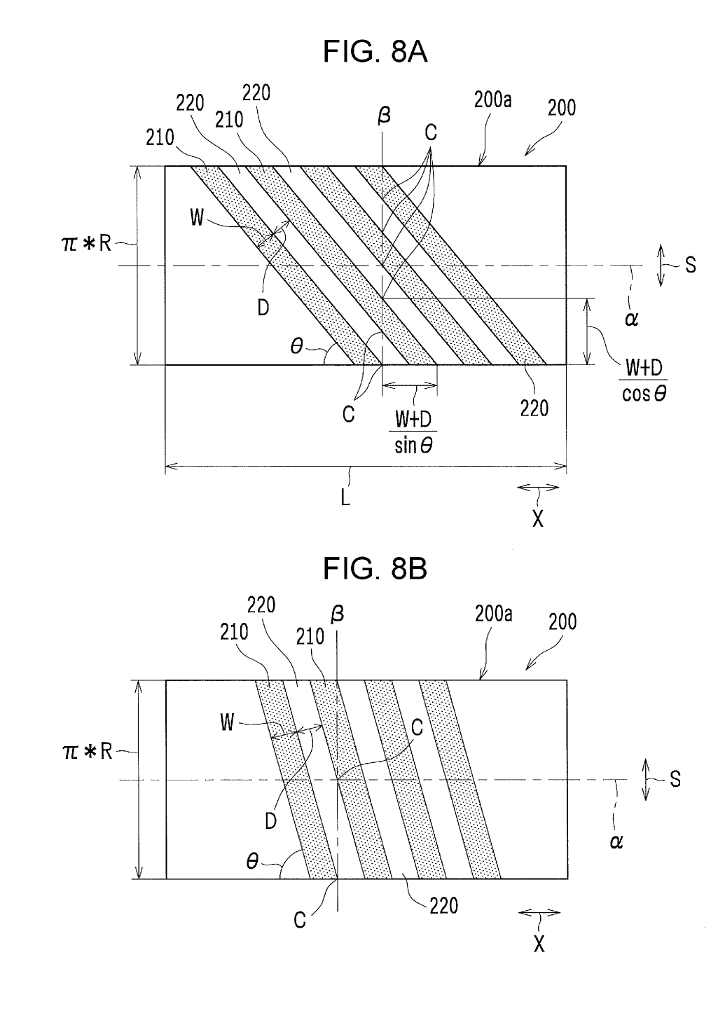

FIG. 2 is a schematic perspective view schematically illustrating a cleaning roller 200a (200) and the charging roller 20 according to the first embodiment. FIG. 3 is a schematic plan view schematically illustrating the cleaning roller 200a (200) according to the first embodiment. FIG. 4 is a schematic sectional view schematically illustrating the cleaning roller 200a (200) according to the first embodiment. FIG. 5 is a schematic perspective view schematically illustrating a cleaning roller 200b (200) and a charging roller 20 according to a second embodiment. FIG. 6 is a schematic sectional view schematically illustrating the cleaning roller 200b (200) according to the second embodiment. FIG. 7 is a schematic sectional view schematically illustrating a cleaning roller 200c (200) according to a third embodiment. FIGS. 8A and 8B are developed views illustrating an outer periphery surface 202a of the cleaning roller 200 developed in a circumferential direction S. FIG. 8A is a view illustrating a case where a twist angle θ is small and FIG. 8B is a view illustrating a case where the twist angle θ is large in a relationship of Equation (1).

In the embodiment, the cleaning roller 200 is in contact with the cleaning object (in this example, the charging roller 20) to clean the charging roller 20. A plurality of uneven portions (projection portions 210 and recess portions 220) extending so as to twist in the circumferential direction S of the cleaning roller 200 are formed on the outer periphery surface 202a of the cleaning roller 200.

According to the embodiment, in a state where the uneven portion (projection portion 210 and recess portion 220) has an angle (twist angle θ) with respect to an axis α (see FIG. 3) of the cleaning roller 200, the outer periphery surface 202a of the cleaning roller 200 may be in contact with a surface 20a of the charging roller 20. Therefore, it is possible to limit a deformation portion in a long-term contact, to part of an axial direction X, so that a change of a friction force may be made small. Consequently, a stable rotation operation may be obtained. In addition, even if performance deformation occurs due to contact with the charging roller 20, it is possible to suppress a fluctuation of the friction force with the charging roller 20 due to the performance deformation. Moreover, the cleaning roller 200 is formed not by spirally winding a strip-shaped cleaning member as in the related art on the rotation shaft but by forming the projection portions 210 and the recess portions 220 on the outer periphery surface 202a of the cleaning roller 200. Therefore, even if the performance deformation occurs due to the contact with the charging roller 20, it is possible to effectively eliminate inconvenience due to the performance deformation such as nonuniformity of a circumferential speed and vibration of the cleaning roller 200, and the fluctuation of the friction force with the charging roller 20. In addition, a driving force from the charging roller 20 may be uniformly obtained over an entire periphery surface. Therefore, the cleaning roller 200 may be stably rotated and a cleaning state of the charging roller 20 may be made uniform. Furthermore, a fluctuation of a rotation load of the cleaning roller 200 may be suppressed. Therefore, inconvenience due to a rotation fluctuation of the cleaning roller 200 may be eliminated. For example, it is possible to maintain image quality stably by uniformity of charging by the charging roller 20 and reduction of jitter on the image. Furthermore, in order to avoid peeling or chipping of the band portion, it is not necessary to provide an unnecessary region in the longitudinal direction in the cleaning roller 200 unlike in the related art. Therefore, and downsizing of the apparatus may be realized.

In the embodiment, the cleaning roller 200 is driven to rotate together with the rotation of the charging roller 20 that is rotated. Therefore, it is possible to reliably clean foreign matters such as the toner attached to the surface 20a of the charging roller 20. In addition, the cleaning roller 200 may drive to rotate by a driving unit (not illustrated). Here, in a case where the cleaning roller 200 drives to rotate, the rotation direction of the cleaning roller 200 may be a counter direction with respect to the rotation direction G2 of the charging roller 20 (same direction as a rotation direction G2 of the charging roller 20). In addition, the rotation direction of the cleaning roller 200 may be a forward direction with respect to the rotation direction G2 of the charging roller 20 (direction opposite to the rotation direction G2 of the charging roller 20). In addition, the circumferential speeds of the cleaning roller 200 and the charging roller 20 may be the same or different.

If the twist angle θ of the projection portion 210 and the recess portion 220 with respect to the axis α is too small, it is easily affected by a permanent distortion. On the other hand, if the twist angle θ is too large, the number of contact portions (for example, the number of edges C) at each position (for example, any position β illustrated in FIGS. 8A and 8B) in the axial direction X of the outer periphery surface 202a of the cleaning roller 200 is reduced. Here, the contact portions are contact portions of the projection portions 210 with the charging roller 20 in one round in the circumferential direction S. Therefore, if the twist angle θ is too large, in a case where a local defect such as deformation or damage of the projection portion 210 occurs, there is less opportunity for the defect to be compensated by other projection portions 210 in one round. Therefore, it is easily affected by a decrease in cleaning ability due to local damage.

As the twist angle θ of the projection portion 210 and the recess portion 220 with respect to the axis α, for example, substantially 5° to 60°, more preferably substantially 15° to 40° may be exemplified. Therefore, it is possible to increase the number (for example, the number of the edges C) of the contact portions of the outer periphery surface 202a of the cleaning roller 200 with the charging roller 20 while being hardly affected by the permanent distortion. Thus, in a case where a local defect such as deformation or damage of the projection portion 210 occurs, the opportunity for the defect to be compensated by other projection portions 210 in one round may be increased. Furthermore, it is difficult to receive the influence of deterioration of the cleaning ability or the like due to a local defect such as deformation or damage of the projection portion 210. In this example, the twist angle θ is substantially 20°.

### Number of Unevenness Per Round

Next, a relationship between a width W of the projection portion 210, a width D of the recess portion 220, an outer diameter R of the cleaning roller 200, the torsion angle θ, and the number of the unevenness N will be described with reference to FIGS. 8A and 8B. Moreover, in FIGS. 8A and. 8B, a vertical axis represents a circumferential distance of the outer periphery surface 202a of the cleaning roller 200 and represents a distance of the cleaning roller 200 in the axial direction X. In FIGS. 8A and 8B, the cleaning roller 200a (200) according to the first embodiment illustrated in FIGS. 1 to 4 is illustrated and the cleaning roller 200b (200) according to the second embodiment illustrated in FIGS. 5 and 6, and the cleaning roller 200c (200) according to the third embodiment illustrated in FIG. 7 may also be similarly applied.

If the width of the projection portion 210 is W, the width of the recess portion 220 is D, the outer diameter (diameter of an outer periphery circle passing through the edge C of the projection portion 210 in the circumferential direction S) of the cleaning roller 200 is R, the torsion angle with respect to the axis α of the projection portion 210 and the recess portion 220 is θ, the circumference ratio is π, and the number of unevenness of the cleaning roller 20 per round is N, Equation (1) is satisfied.

N=π*R/{[(W+D)/sin θ]*tan θ}

N=π*R/{[(W+D)/sin θ]*(sin θ/cos θ)}

N=π*R/{(W+D)/cos θ}

N=π*R*cos θ/(W+D) Equation (1)

As in developed views illustrated in FIGS. 8A and 8B, N is an integer value. The values of θ and (W+D) are determined so as to satisfy this condition. This is because θ and W+D may take consecutive values since the cleaning member 202 is the elastic member such as a foam sponge. If the cleaning member 202 is a rigid body, when W+D and N are determined, θ is uniquely determined. In addition, when θ and N are determined, W+D is uniquely determined. Therefore, for example, as described later, when the cleaning member 202 (foam) is formed while twisting, W+D is determined by a shape of an extrusion port, and the cleaning member 202 may be molded by controlling θ (torsion amount) so as to be arbitrary N.

### EXAMPLE 1

Next, with respect to Equation (1), a cleaning performance by the cleaning roller 200 was evaluated by changing the outer diameter R, the width W of the projection portion 210, the width D of the recess portion 220, and the torsion angle θ. In Example 1, a generation state of density unevenness (vertical streak) due to charging failure of the charging roller 20 was investigated.

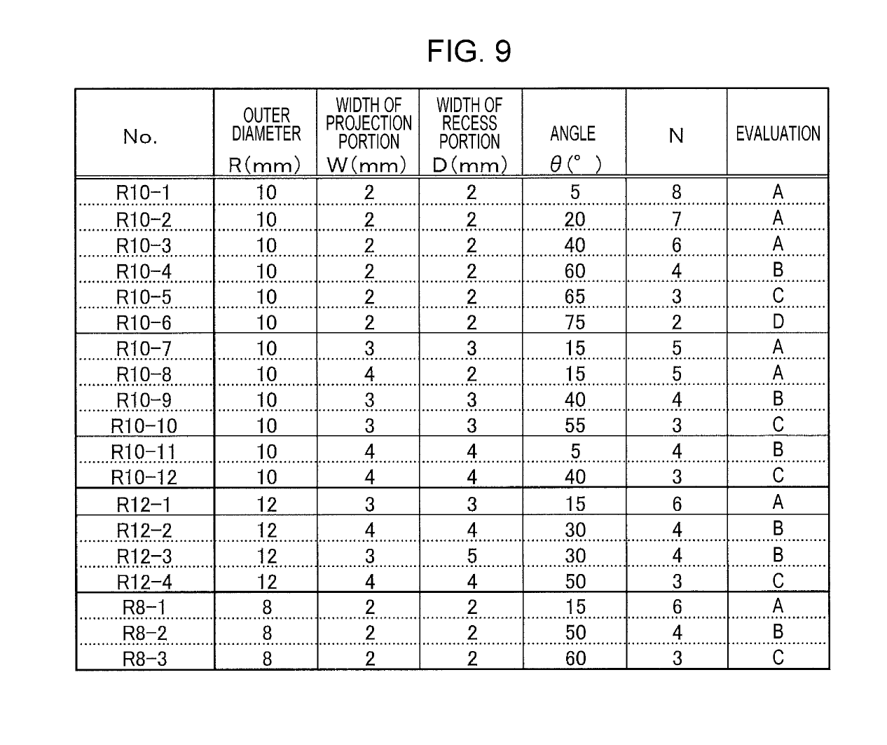

FIG. 9 is a table illustrating evaluation results of Example 1. In FIG. 9, “A” indicates that there is no density unevenness and is very good. “B” indicates there is little density unevenness and is good. “C” indicates that although it has slight density unevenness, it may withstand practical use. “D” includes that the density unevenness may not withstand practical use.

As illustrated in FIG. 9, N represented by π*R*cos θ/(W+D) of Equation (1) is preferably 3 or more, more preferably 4 or more. Therefore, in a case where a local defect such as deformation or damage of the projection portion 210 occurs, the opportunity for the defect to be compensated by other projection portions 210 in one round may be increased. That is, the projection portion 210 may be in contact with the charging roller 20 at many contact portions (for example, the edges C) in one round in the circumferential direction S. Therefore, even in a case where there are variations (local defect such as deformation or damage of the projection portion 210) in materials used for the cleaning member 202, it is possible to provide the cleaning ability stably and effectively.

### Unevenness Ratio of One Uneven Portion With Respect to Entire Length of Cleaning Region

Next, a relationship between the width W of the projection portion 210, the width D of the recess portion 220, the torsion angle θ, and an unevenness ratio M will be described with reference to FIGS. 8A and 8B.

If the entire length of the cleaning region of the cleaning roller 200 to the charging roller 20 in the axial direction X is L, and the unevenness ratio of one uneven portion (projection portion 210 and recess portion 220) with respect to the entire length L of the cleaning region is M, Equation (2) is satisfied.

M=(W+D)/sin θ/L Equation (2)

### EXAMPLE 2

Next, in Equation (2), the cleaning ability of the cleaning roller 200 was evaluated by making the entire length L of the cleaning region be constant, and the outer diameter R, the torsion angle θ, the width W of the projection portion 210, and the width D of the recess portion 220 be changed. In Example 2, a generation state of banding (shading unevenness in an image advancing direction) was investigated.

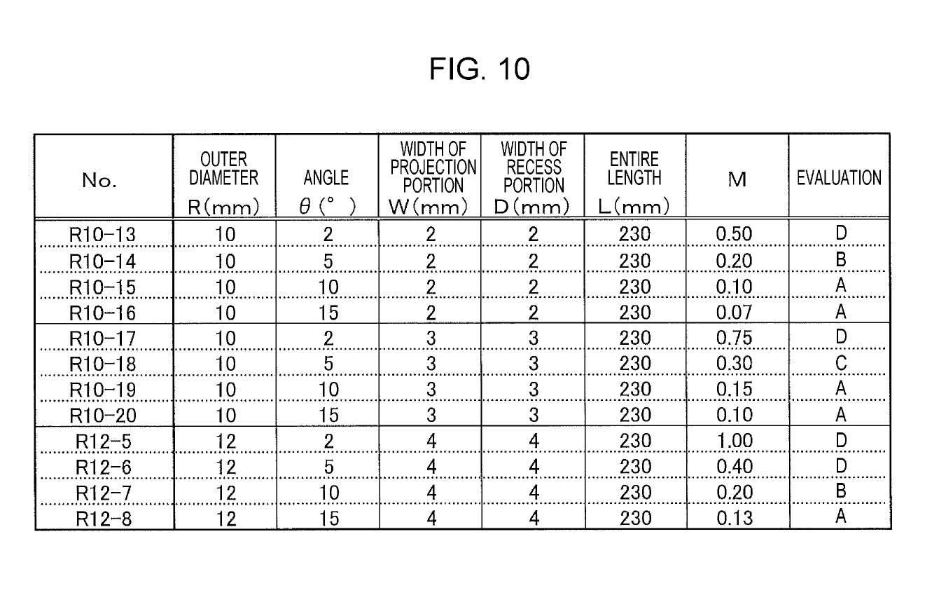

FIG. 10 is a table illustrating evaluation results of Example 2. In FIG. 10, “A” indicates that there is no banding and is very good. “B” indicates there is little banding and is good. “C” indicates that although it has slight banding, it may withstand practical use. “D” includes that the banding may not withstand practical use. Moreover, R10-1 of Example 1 was used as R10-14 of Example 2 and R10-7 of Example 1 was used as R10-20 of Example 2.

As illustrated in FIG. 10, M represented by (W+D)/sin θ/L of Equation (2) is preferably 0.3 or less, more preferably 0.2 or less. Therefore, it is possible to suppress a state where the projection portion 210 and the recess portion 220 of a specific position of the cleaning member 202 are in contact with each other for a long period of time. Therefore, it is possible to stabilize the variation in the driving load of the cleaning member 202 due to a formation defect of the cleaning member 202. Moreover, it is possible to suppress an image defect resulting from the driving load such as banding generation.

In the embodiment, the projection portion 210 and the recess portion 220 are formed over the entire region of the cleaning roller 200 in the axial direction X in the outer periphery surface 202a. Therefore, it is possible to clean the entire region of the charging roller 20 in the axial direction X of the cleaning roller 200. Furthermore, it is possible to effectively avoid peeling from both ends of the cleaning roller 200, so that a strong structure may be obtained.

In the embodiment, the width D of the recess portion 220 is equal to the width W of the projection portion 210 or larger than the width W of the projection portion 210 (see FIG. 4). Therefore, when the cleaning roller 200 is compressed and deformed by being in contact with the charging roller 20, it is possible to secure a relief space of a deformed portion of the projection portion 210 in the recess portion 220. Therefore, permanent distortion may be hardly caused and a permanent distortion amount may be reduced. In addition, it is possible to make it easy to store the foreign matters such as the toner in the recess portion 220 and it is possible to effectively avoid re-adhesion to the charging roller 20 due to a storing operation. Here, the width W of the projection portion 210 and the width D of the recess portion 220 are different in the radial direction, the width W of the projection portion 210 may be a width of an outer end in the radial direction and the width D of the recess portion 220 may be a width of an inner end in the radial direction. In addition, the width W of the projection portion 210 and the width D of the recess portion 220 may be a width of a center portion in the radial direction, or may be an average of widths of a predetermined plurality of portions (for example, the outer end and the inner end) in the radial direction.

### Relationship Between Depth of Recess Portion and Compression Deformation Amount of Projection Portion

Next, a relationship between a depth (distance in the radial direction) of the recess portion 220 and a compression deformation amount (maximum deformation amount, a so-called biting amount) of the projection portion 210 when the projection portion 210 cleans the charging roller 20 will be described.

Meanwhile, in a case where the cleaning roller 200 is in pressure contact with the charging roller 20, if both the projection portion 210 and the recess portion 220 are in contact with the charging roller 20, when the cleaning roller 200 is compressed and deformed by being in contact with the charging roller 20, it is hard to secure the relief space of a deformed portion of the projection portion 210 in the recess portion 220. Therefore, the permanent distortion may be easily caused and the permanent distortion amount may be increased. Therefore, it is preferable that the permanent distortion is hardly caused and the permanent distortion amount is reduced.

Regarding this, the cleaning performance of the cleaning roller 200 by making a depth of the recess portion 220 be H, the compression deformation amount of the projection portion 210 when the projection portion 210 cleans the charging roller 20 be F (see FIGS. 2 and 4 to 7), and the depth H and the compression deformation amount E be changed was evaluated. In Example 3, after the compression deformation of the projection portion 210 was left for a predetermined time period, a degree of generation of the banding was investigated.

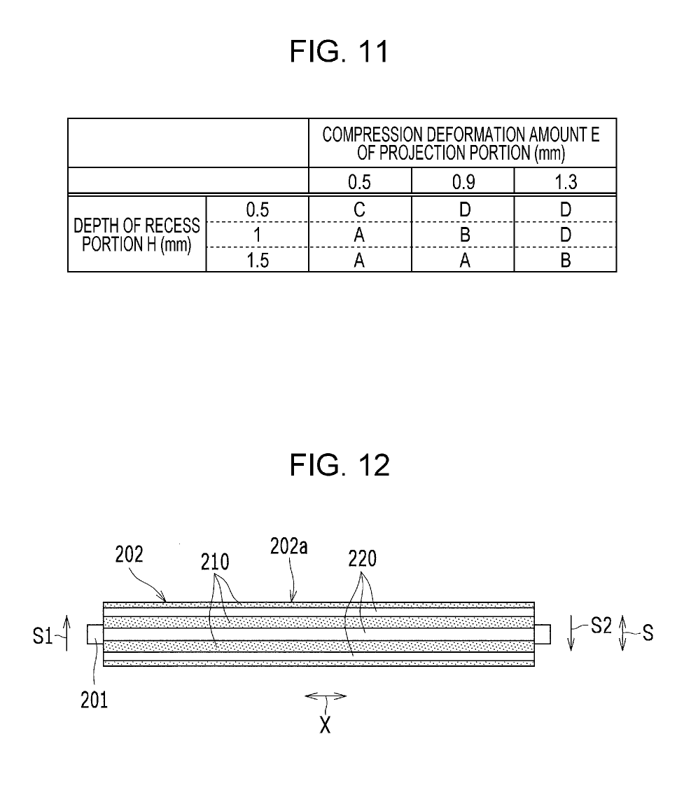

FIG. 11 is a table illustrating evaluation results of Example 3. In FIG. 11, “A” indicates that there is no banding and is very good. “B” indicates that the degree of the generation of the banding is small and is good. “C” indicates that although the degree of the generation of the banding is slightly large, it may withstand practical use. “D” includes that the degree of the generation of the banding may not withstand practical use. Moreover, in Example 3, R10-7 of Example 1 was used.

As illustrated in FIG. 11, it is preferable that a relation of E≤H is satisfied. That is, it is preferable that the depth H of the recess portion 220 is equal to the compression deformation amount E or is larger than the compression deformation amount E. Therefore, when the cleaning roller 200 is compressed and deformed by being in contact with the charging roller 20, it is possible to secure the relief space of the deformed portion of the projection portion 210 in the recess portion 220. Therefore, the permanent distortion may be hardly caused and the permanent distortion amount may be effectively reduced. Furthermore, it is possible to effectively avoid re-adhesion to the charging roller 20 due to the storing operation. In addition, it is possible to suppress a variation in the driving state due to a change of an outer diameter of the cleaning roller 200. This is effective for reducing the permanent distortion.

In the embodiment, the projection portion 210 has corner portions configuring edges C on adjacent surfaces. Therefore, it is possible to improve the cleaning ability by a scraping operation by the edges C.

### First Embodiment

In the cleaning roller 200a (200) according to a first embodiment, the projection portion 210 has a quadrilateral shape or a substantially quadrilateral shape (referred to FIGS. 2 to 4) in a sectional view (viewed from the axial direction X). Therefore, the number of the edges C per one projection portion 210 in the circumferential direction S, which is in contact with the charging roller 20 on the outer periphery surface 202a of the cleaning roller 200a (200) may be set to two. Therefore, it is difficult to receive the influence of reduction of the cleaning ability or the like due to the local defect such as the deformation or damage of the projection portion 210 compared to a case where the number of the edges C per one projection portion 210 is one (see FIGS. 5 to 7). In addition, it is possible to reliably scrape the foreign matters of the charging roller 20 by the edges C. Here, the quadrilateral shape or the substantially quadrilateral shape may be a square shape or a substantially square shape. In addition, the quadrilateral shape or the substantially quadrilateral shape may be a rectangular shape or a substantially rectangular shape elongated in the circumferential direction, or a rectangular shape or a substantially rectangular shape that is long in the radial direction. In addition, the quadrilateral shape or the substantially quadrilateral shape may be a trapezoidal shape or a substantially trapezoidal shape in which an outside upper bottom is larger than an inside lower bottom in the radial direction, or may be a trapezoidal shape or a substantially trapezoidal shape in which an outside upper bottom is smaller than an inside lower bottom in the radial direction.

### Second Embodiment

In the cleaning roller 200b (200) according to a second embodiment, a projection portion 210 has a triangular shape in a sectional view (viewed from the axial direction) (see FIGS. 5 and 6). Therefore, the projection portion 210 may be in contact with the charging roller 20 in a state where the edge C (pointed portion) is erect. Therefore, it is possible to further improve the cleaning ability by the scraping operation by the edge C. Here, the triangular shape may be an equilateral triangle shape, an isosceles triangle shape, or a right triangle shape. In a case where the triangular shape is other than the equilateral triangle shape or the isosceles triangle shape, it is preferable that an inclination angle of a side on a downstream side is larger than that of a side on an upstream side in the rotation direction of the cleaning roller 200 among sides configuring the edges. Therefore, it is possible to reliably scrape the foreign matters of the charging roller 20 by the edge C.

### Third Embodiment

In the cleaning roller 200c (200) according to a third embodiment, a projection portion 210 has a circular saw shape (see FIG. 7) in a sectional view (viewed from the axial direction). Therefore, the projection portion 210 may be in contact with the charging roller 20 in a state where the edge C (pointed portion) is sharpened. Therefore, it is possible to further improve the cleaning ability by the scraping operation by the edge C. In this case, it is preferable that a tip of the projection portion 210 having the circular saw shape faces the downstream side in a rotation direction Q of the cleaning roller 200c (200). Therefore, it is possible to reliably scrape the foreign matters of the charging roller 20 by the edge C.

### Method of Manufacturing Cleaning Roller

The cleaning roller 200 according to the embodiment may be manufactured as in the following first and second aspects.

### Method of Manufacturing Cleaning Roller of First Aspect

FIG. 12 is a schematic plan view schematically illustrating a state before a cleaning member 202 is fixed to a rotation shaft 201 in a method of manufacturing a cleaning roller 200 of the first aspect. In FIG. 12, an example of manufacturing the cleaning roller 200a (200) according to the first embodiment illustrated in FIGS. 2 to 4 is illustrated.

In the method of manufacturing the cleaning roller 200 of the first aspect, first, the rotation shaft 201 of the cleaning roller 200 is inserted into a cylindrical hole 202b (see FIG. 4) of the cylindrical cleaning member 202. The plurality of uneven portions (projection portions 210 and recess portions 220) extending in the longitudinal direction is formed on the outer periphery surface 202a of the cleaning roller 200 in the axial direction X. The cylindrical cleaning member 202 may be formed by a known predetermined molding method of the related art. Such as predetermined molding method is not particularly limited as long as the cleaning member 202 is formed in a cylindrical shape, and a plurality of projection portions 210 and recess portions 220 extending in the longitudinal direction are formed on the outer periphery surface 202a in the axial direction X. Although not limited thereto, such a molding method may be exemplified by extrusion molding or die-cutting molding. In the example, in the cleaning member 202, the outer diameter is 10 mm, the width of the projection portion 210 is 2 mm, the width of the recess portion 220 is 2 mm, the depth of the recess portion 220 is 2 mm, the diameter of the cylindrical hole 202b is 4 mm. In addition, in the rotation shaft 201, the diameter is 4 mm.

Next, in a state where the cleaning member 202 into which the rotation shaft 201 of the cleaning roller 200 is inserted is twisted in the circumferential direction S, the cleaning member 202 and the rotation shaft 201 are fixed. Here, in a state where the rotation shaft 201 is inserted into the cylindrical hole 202b of the cleaning member 202, the cleaning member 202 may be twisted along the circumferential direction S. In addition, the cleaning member 202 may be twisted along the circumferential direction S while the rotation shaft 201 is inserted into the cylindrical hole 202b of the cleaning member 202. In addition, as an aspect in which the cleaning member 202 is twisted in the circumferential direction S, an aspect in which the cleaning member 202 is twisted toward only either one side S1 and the other side S2 in the circumferential direction S, or an aspect in which the cleaning member 202 is twisted toward both one side S1 and the other side S2 in the circumferential direction S may be exemplified. Therefore, it is possible to adjust the torsion angle θ when the cleaning member 202 and the rotation shaft 201 are fixed. Therefore, it is possible to easily form the projection portion 210 and the recess portion 220 in an optimum twisted state according to use conditions of the cleaning roller 200. Moreover, fixing of the cleaning member 202 and the rotation shaft 201 may be performed by heating the rotation shaft 201 at a predetermined temperature, melting a contact portion of the cleaning member 202 with the rotation shaft 201, and then cooling the contact portion, and welding the cleaning member 202 to the rotation shaft 201. For example, before the rotation shaft 201 of the cleaning roller 200 is inserted into the cylindrical hole 202b of the cleaning member 202, a heat meltable adhesive may be applied to a periphery surface of the rotation shaft 201. In addition, fixing of the cleaning member 202 and the rotation shaft 201 is not particularly limited thereto and an adhesive such as a solvent type adhesive may be used.

Moreover, in the method of manufacturing the cleaning roller 200 of the first aspect, the cleaning roller 200 such as the cleaning roller 200b according to the second embodiment illustrated in FIGS. 5 and 6, and the cleaning roller 200c according to the third embodiment illustrated in FIG. 7 may be manufactured in a similar manner.

### Method of Manufacturing Cleaning Roller of Second Aspect

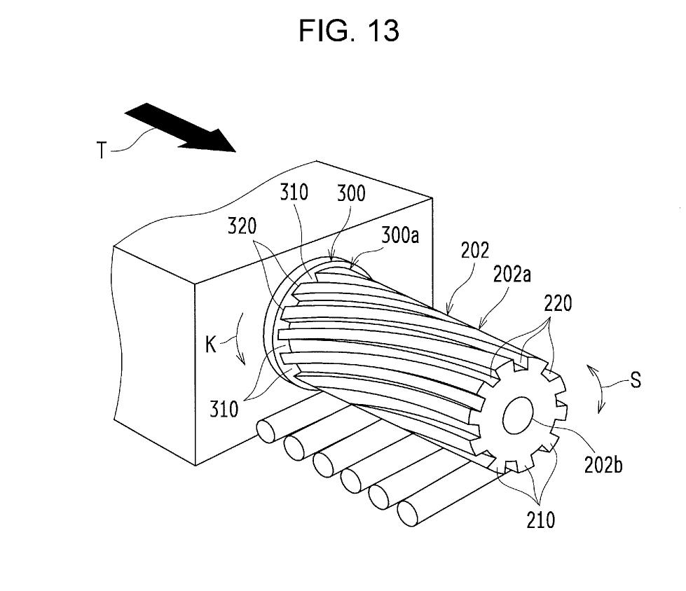

FIG. 13 is a schematic perspective view schematically illustrating a state where the cleaning member 202 is extrusion-molded in a method of manufacturing the cleaning roller 200 of a second aspect. In FIG. 13, an example, in which the cleaning roller 200a (200) of the first embodiment illustrated in FIGS. 2 to 4 is manufactured, is illustrated.

In the method of manufacturing the cleaning roller 200 of the second aspect, first, an extrusion molding material (not illustrated) is extruded toward an extrusion molding hole 300a of an extrusion molding die 300. The extrusion molding die 300 has the extrusion molding hole 300a having a circular cross section in which a plurality of uneven portions (injection molding projection portions 310 and injection molding recess portions 320) for injection molding are formed throughout the entire circumferential direction S.

Next, when the extrusion molding material passes through the extrusion molding hole 300a of the extrusion molding die 300 while extruding the extrusion molding material, the extrusion molding die 300 is rotated in a predetermined rotation direction K around the axis along an extrusion direction T of the extrusion molding material. Therefore, the cleaning member 202, in which a plurality of projection portions 210 and recess portions 220 extending so as to twist in the circumferential direction S are formed, is molded on the outer periphery surface 202a. In the example, the cleaning member 202 is a cylindrical cleaning member having the cylindrical hole 202b at a center portion.

### Method of Manufacturing Cleaning Roller of Third Aspect

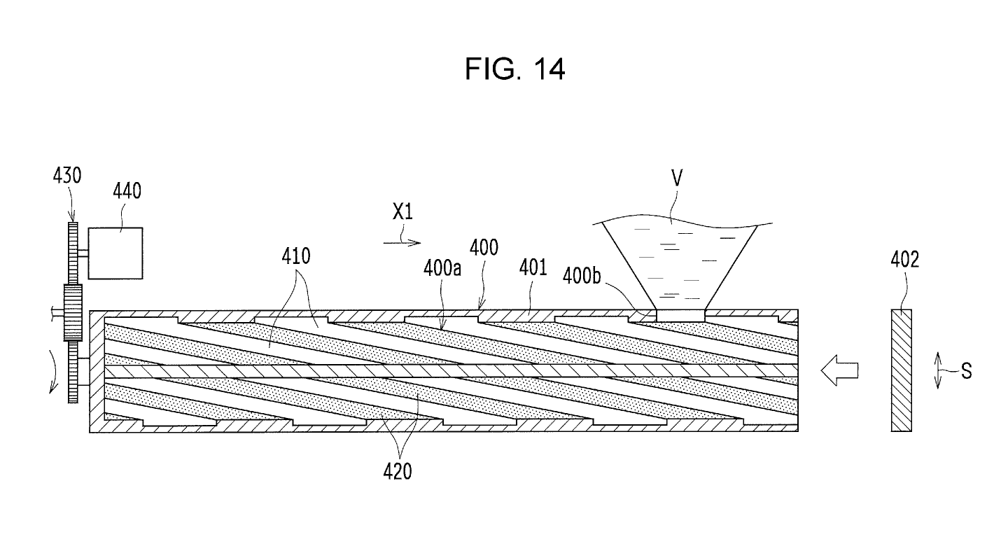

FIG. 14 is a schematic sectional view schematically illustrating an injection molding die 400 for extrusion-molding the cleaning member 202 in a method of manufacturing a cleaning roller 200 of a third aspect. In FIG. 14, an example, in which the cleaning roller 200a (200) of the first embodiment illustrated in FIGS. 2 to 4 is manufactured, is illustrated.

In the method of manufacturing the cleaning roller 200 of the third aspect, the injection molding die 400 is filled with an injection molding material V. The injection molding die 400 is formed of a plurality of uneven portions (injection molding recess portions 410 and injection molding projection portions 420) for injection molding extending so as to twist in the circumferential direction S. Specifically, a pair of injection molding dies 401 and 402 configuring the injection molding die 400 are clamped to injection fill a filling port 400b of the injection molding die 400 with the injection molding material V. In the example, the injection molding die 400 is a die for forming the cylindrical hole 202b of the cleaning member 202.

Next, the injection molding material V with which the injection molding die 400 is filled is solidified (cooled and solidified). Therefore, the cleaning member 202, in which the plurality of uneven portions (projection portions 210 and recess portions 220) are formed so as to twist in the circumferential direction S, is molded on the outer periphery surface 202a.

Next, the injection molding die 400 is rotated in a predetermined rotation direction around the axis. Therefore, the cleaning member 202 is stripped from the injection molding die 400. Specifically, the pair of injection molding dies 401 and 402 are opened and a rotation driving unit 440 (specifically, a driving motor) drives to rotate via a driving transmission unit 430 (for example, a gear train) to rotate the injection molding die 401. In this case, the cleaning member 202 is moved in a pull-out direction X1 while holding the cleaning member 202 so as not to be driven and rotated with respect to the rotation of the injection molding die 401 by a moving mechanism (not illustrated). Then, the cleaning member 202 pulls out of the injection molding die 401. Therefore, the cleaning member 202 may be removed from the injection molding die 401. The rotation number and the rotation speed of the rotation driving unit 440 may be adjusted by the number and the width of the injection molding recess portions 410 and the injection molding projection portions 420 in the injection molding die 401.

### Common Steps of Second Aspect and Third Aspect

In the method of manufacturing the cleaning roller 200 of the second aspect and the third aspect, the rotation shaft 201 of the cleaning roller 200 is inserted into the cylindrical hole 202b of the cleaning member 202 in which the projection portion 210 and the recess portion 220 are formed. Thereafter, the cleaning member 202 and the rotation shaft 201 of the cleaning roller 200 are fixed (specifically, adhered).

According to the method of manufacturing the cleaning roller 200 of the second aspect and the third aspect, the rotation shaft 201 and the cleaning member 202 may be fixed without performing a twisting operation. Therefore, this makes it easy to fix the rotation shaft 201 and the cleaning member 202. Furthermore, the torsion angle θ of the cleaning member 202 may be stably formed. Therefore, image formation may be stabilized. Fixing of the cleaning member 202 and the rotation shaft 201 may be performed in a similar manner to the method of manufacturing of the first aspect.

Moreover, in the method of manufacturing the cleaning roller 200 of the second aspect and the third aspect, the cleaning roller 200 such as the cleaning roller 200b according to the second embodiment illustrated in FIGS. 5 and 6, and the cleaning roller 200c according to the third embodiment illustrated in FIG. 7 may be manufactured in a similar manner.

### Other Embodiments

In the embodiment, the cleaning object is the charging member (specifically, the charging roller 20), but may be a transfer charging member such as a transfer charging roller or may be various rollers. In addition, the cleaning object may be, for example, not only a roller but also a photosensitive drum, a photosensitive belt, or a transfer belt.

The disclosure is not limited to the embodiments described above and may be implemented in various other forms. Therefore, such embodiments are merely illustrative in all respects, and should not be construed as limiting. The scope of the disclosure is indicated by the scope of the claims, and is not bound in any way in the description body of the specification. Furthermore, all variations and modifications falling within the equivalent scope of the claims are within the scope of the disclosure.

The present disclosure contains subject matter related to that disclosed in Japanese Priority Patent Application JP 2017-215041 filed in the Japan Patent Office on Nov. 7, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A cleaning roller which is in contact with a cleaning object to clean the cleaning object,
wherein a plurality of uneven portions extending so as to twist in a circumferential direction of the cleaning roller are formed on an outer periphery surface of the cleaning roller.

2. The cleaning roller according to claim 1,
wherein in a case where a width of a projection portion of the uneven portion is W, a width of a recess portion of the uneven portion is D, an outer diameter of the cleaning roller is R, a torsion angle of the uneven portion with respect to an axis of the cleaning roller is θ, and a circumference ratio is π, the following equation is satisfied:
N=π*R*cos θ/(W+D)
where, N is 3 or more.

3. The cleaning roller according to claim 1,
wherein in a case where a width of a projection portion of the uneven portion is W, a width of a recess portion of the uneven portion is D, a torsion angle of the uneven portion with respect to an axis of the cleaning roller is θ, and an entire length of a cleaning region of the cleaning roller to the cleaning object in an axial direction is L, the following equation is satisfied:
M=(W+D)/sin θ/L
where M is 0.3 or less.

4. The cleaning roller according to claim 1,
wherein the uneven portion is formed over an entire region of the cleaning roller in an axial direction on the outer periphery surface.

5. The cleaning roller according to claim 1,
wherein a width of a recess portion of the uneven portion is equal to or larger than a width of a projection portion of the uneven portion.

6. The cleaning roller according to claim 1,
wherein in a case where a depth of a recess portion of the uneven portion is H, and a compression deformation amount of a projection portion when the projection portion of the uneven portion cleans the cleaning object is E, a relation E≤H is satisfied.

7. The cleaning roller according to claim 1,
wherein a projection portion of the uneven portion has a corner portion configuring an edge on adjacent surfaces.

8. The cleaning roller according to claim 7,
wherein the projection portion of the uneven portion has a quadrilateral shape or a substantially quadrilateral shape in a sectional view.

9. The cleaning roller according to claim 7,
wherein the projection portion of the uneven portion has a triangular shape in a sectional view.

10. A charging device comprising:
the cleaning roller according to claim 1; and
a charging roller,
wherein the cleaning roller is in contact with the charging roller to clean the charging roller.

11. The charging device according to claim 10,
wherein the cleaning roller its driven to rotate together with the rotation of the charging roller that is rotated.

12. An image forming apparatus comprising:
the cleaning roller according to claim 1.

13. An image forming apparatus comprising:
the charging device according to claim 10.

14. A method of manufacturing a cleaning roller which is in contact with a cleaning object to clean the cleaning object, the method comprising:
inserting a rotation shaft of the cleaning roller into a cylindrical hole of a cylindrical cleaning member in which a plurality of uneven portions extending in a longitudinal direction are formed on an outer periphery surface along an axial direction; and
fixing the cleaning member and the rotation shaft in a state where the cleaning member, into which the rotation shaft of the cleaning roller is inserted, is twisted in a circumferential direction.

15. A method of manufacturing a cleaning roller which is in contact with a cleaning object to clean the cleaning object, the method comprising:
extruding an extrusion molding material toward an extrusion molding hole of an extrusion molding die having the extrusion molding hole having a circular cross section in which a plurality of uneven portions for injection molding are formed throughout an entire circumferential direction; and
molding a cleaning member, in which a plurality of uneven portions extending so as to twist in a circumferential direction are formed on an outer periphery surface by rotating the extrusion molding die in a predetermined rotation direction around an axis along an extrusion direction of the extrusion molding material when the extrusion molding material passes through the extrusion molding hole of the extrusion molding die.

16. A method of manufacturing a cleaning roller which is in contact with a cleaning object to clean the cleaning object, the method comprising:
filling an injection molding die in which a plurality of uneven portions for injection molding extending so as to twist in a circumferential direction are formed on an inner periphery surface, with an injection molding material;
molding a cleaning member in which a plurality of uneven portions extending so as to twist in a circumferential direction are formed on an outer periphery surface by solidifying the injection molding material with which the injection molding die is filled; and
stripping the cleaning member from the injection molding die by rotating the injection molding die around an axis.
